(19) United States
(12) Patent Application Publication
(10) Pub. No.: US 2026/0129005 A1
(43) Pub. Date: May 7, 2026

(54) Exponentially Weighted Scoring of Calculated Resource Availability for Automated Network Element Selection, Augmentation, and Service Delivery

(71) Applicant: Level 3 Communications, LLC, Denver, CO (US)

(72) Inventor: Bobby W. Metz, Johnson City, TN (US)

(73) Assignee: Level 3 Communications, LLC, Denver, CO (US)

(21) Appl. No.: 19/380,006

(22) Filed: Nov. 5, 2025

Related U.S. Application Data
(60) Provisional application No. 63/716,434, filed on Nov. 5, 2024.

(51) Int. Cl. H04L 47/70; G06F 9/54

(52) U.S. Cl. CPC H04L 47/82; G06F 9/547

(57) ABSTRACT

Novel tools and techniques are provided for implementing exponentially weighted scoring of calculated resource availability for automated network element selection, augmentation, and service delivery. After receiving a request for network services and measurement data associated with a plurality of network elements capable of providing the requested network services, a computing system may calculate a weighted score for each of a plurality of resources that is available on each network element. Each weighted score for a corresponding resource may be based on an exponential decay function of a difference between a limit value corresponding to an allocatable amount of the corresponding resource and a measured usage value based on the measurement data. For each network element, the computing system may calculate an availability score based on the weighted scores, and may output either the availability score and/or a resource allocation decision for that network element.

### CROSS-REFERENCE TO RELATED APPLICATIONS

This application claims the benefit of U.S. Provisional Application No. 63/716,434 filed Nov. 5, 2024, entitled “Exponentially Weighted Scoring of Calculated Resource Availability for Automated Network Element Selection, Augmentation, and Service Delivery,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing network resource provisioning, and, more particularly, to methods, systems, and apparatuses for implementing exponentially weighted scoring of calculated resource availability for automated network element selection, augmentation, and service delivery.

### BACKGROUND

Network resources are provisioned to a plurality of customers of a service provider on a frequent basis. Determining accurate availability of such resources ensures efficient allocation and/or provisioning of resources. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing exponentially weighted scoring of calculated resource availability for automated network element selection, augmentation, and service delivery, in accordance with various embodiments.

FIG. 2A depicts an example graphical representation of resource consumption versus availability score components that corresponds to the exponentially weighted scoring of calculated resource availability for automated network element selection, augmentation, and service delivery, in accordance with various embodiments.

FIG. 2B depicts an example graphical representation of maximum, minimum, and limited thresholds that may be used when implementing exponentially weighted scoring of calculated resource availability for automated network element selection, augmentation, and service delivery, in accordance with various embodiments.

FIGS. 2C and 2D depict various example sets of calculation results that correspond to implementation of exponentially weighted scoring of calculated resource availability for automated network element selection, augmentation, and service delivery, in accordance with various embodiments.

FIGS. 3A-3D depict flow diagrams illustrating an example method for implementing exponentially weighted scoring of calculated resource availability for automated network element selection, augmentation, and service delivery, in accordance with various embodiments.

FIG. 4 depicts a flow diagram illustrating another example method for implementing exponentially weighted scoring of calculated resource availability for automated network element selection, augmentation, and service delivery, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

In various examples, a computing system may receive a request for network services, and may receive measurement data associated with a plurality of network elements capable of providing the requested network services. In an example, the request may include a requested amount of network resources. In other examples, if no specific amount is requested, a default amount of network resources may be provided. The computing system may calculate a weighted score for each of a plurality of resources that is available on each of the plurality of network elements. Each weighted score for a corresponding resource of the plurality of resources may be based on an exponential decay function of a difference between a limit value and a measured usage value, the limit value may correspond to an allocatable amount of the corresponding resource, and the measured usage value may be based on the measurement data. For each network element, the computing system may calculate an availability score that may be based on the weighted scores for resources of that network element. The computing system may output either the availability score for each of the plurality of network elements and/or a resource allocation decision for that network element based on the determined availability of that network element for providing the requested network services.

These and other aspects of the exponentially weighted scoring of calculated resource availability for automated network element selection, augmentation, and service delivery are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by a computing system, a request for network services; and receiving, by the computing system, measurement data associated with a plurality of network elements capable of providing the requested network services. The method may further include calculating, by the computing system, a weighted score for each of a plurality of resources that is available on each of the plurality of network elements. In some examples, each weighted score for a corresponding resource of the plurality of resources may be based on an exponential decay function of a difference between a limit value and a measured usage value. In examples, the limit value may correspond to an allocatable amount of the corresponding resource. In some cases, the measured usage value may be based on the measurement data. The method may further include, for each network element, calculating, by the computing system, an availability score that may be based on the weighted scores for resources of that network element. In an example, the method may further include outputting, by the computing system, the availability score for each of the plurality of network elements. In another example, alternatively or additionally, the method may further include, for each of the plurality of network elements, determining, by the computing system, whether that network element is available for providing the requested network services, based on the availability score for that network element; and outputting, by the computing system, a resource allocation decision for that network element based on the determined availability of that network element for providing the requested network services.

In another aspect, the technology relates to a system, including a computing system, including a processing system and memory coupled to the processing system. The memory includes computer executable instructions that, when executed by the processing system, causes the system to perform operations including: receiving a request for network services; receiving measurement data associated with plurality of network elements capable of providing the requested network services; determining whether a requesting entity for whom the network services are being requested is a first type of customer who has already been provisioned with resources on at least one of the plurality of network elements or a second type of customer who has not already been provisioned with resources on any of the plurality of network elements; and calculating a weighted score for each of a plurality of resources that is available on each of the plurality of network elements. In some examples, each weighted score for a corresponding resource of the plurality of resources may be based on an exponential decay function of a difference between a limit value and a measured usage value. In examples, the limit value may correspond to an allocatable amount of the corresponding resource. In some cases, the measured usage value may be based on the measurement data. The operations may further include, for each network element, calculating an availability score that may be based on the weighted scores for resources of that network element. In an example, the operations may further include outputting the availability score for each of the plurality of network elements. In another example, alternatively or additionally, the operations may further include, for each of the plurality of network elements, determining whether that network element is available for providing the requested network services, based on the availability score for that network element, which may be based on the type of customer; and outputting a resource allocation decision for that network element based on the determined availability of that network element for providing the requested network services.

In yet another aspect, the technology relates to a method, including: receiving, by a computing system and from a requesting device, a request for network services; and sending, by the computing system to a resource availability calculator, the request for network services. The method may further include receiving, by the computing system and from the resource availability calculator, at least one of: an availability score for each of plurality of network elements capable of providing the requested network services; and/or a resource allocation decision for each of the plurality of network elements based on a determined availability of that network element for providing the requested network services. In examples, the availability score for each network element being calculated by the resource availability calculator based on a weighted score for each of a plurality of resources that is available on each of that network element. In some examples, each weighted score for a corresponding resource of the plurality of resources may be based on an exponential decay function of a difference between a limit value and a measured usage value. In examples, the limit value may correspond to an allocatable amount of the corresponding resource. In some cases, the measured usage value may be based on the measurement data. In some examples, the determined availability of that network element may be based on the availability score for that network element. The method may further include sending, by the computing system and to the requesting device, at least one of the availability score or the resource allocation decision for each of the plurality of network elements.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

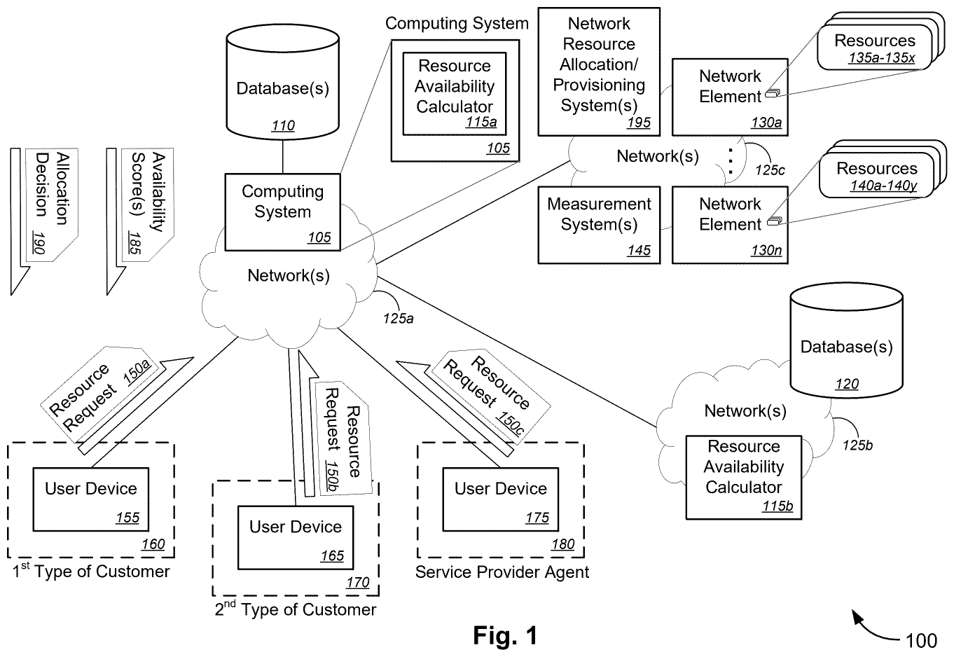

Turning to the embodiments as illustrated by the drawings, FIGS. 1-5 illustrate some of the features of methods, systems, and apparatuses for implementing network resource provisioning, and, more particularly, to methods, systems, and apparatuses for implementing exponentially weighted scoring of calculated resource availability for automated network element selection, augmentation, and service delivery, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing exponentially weighted scoring of calculated resource availability for automated network element selection, augmentation, and service delivery, in accordance with various embodiments. In the non-limiting example of FIG. 1, system 100 may include computing system 105 and corresponding database(s) 110. System 100 may further include a resource availability calculator 115 including resource availability calculator 115a and/or 115b, in some cases, with corresponding database(s) (e.g., database(s) 120 corresponding to resource availability calculator 115b, or the like). In an example, resource availability calculator 115a may be integrated with (or otherwise local to) computing system 105 in network(s) 125a. In another example, alternatively or additionally, resource availability calculator 115b may be remote from computing system 105, and may be located in network(s) 125b, which may be separate from network(s) 125a. In the latter case, computing system 105 may communicate with resource availability calculator 115b via an application programming interface (“API”) or other interface or portal. System 100 may further include a plurality of network elements 130a-130n (collectively, “network elements 130” or the like) in network(s) 125c. The plurality of network elements is each capable of providing network services via a plurality of resources 135a-135x or 140a-140y (collectively, “resources 135,” “resources 140,” “resources 135 and/or 140” or the like). Herein, n, x, and y are non-negative integer numbers that may be either all the same as each other, all different from each other, or some combination of same and different (e.g., one set of two or more having the same values with the others having different values, a plurality of sets of two or more having the same value with the others having different values, etc.). System 100 may further include a measurement system(s) 145 (also referred to herein as a “measurement data source(s)”) that may measure and/or collect data associated with the network elements among the plurality of network elements 130, and that may store the collected measurement data in a database(s) (e.g., database(s) 110 and/or 120).

In some examples, the computing system 105 may include at least one of a resource availability calculator (e.g., resource availability calculator 115a, or the like), a network resource allocation or provisioning system (e.g., network resource allocation or provisioning system 195, or the like), or a server, and/or the like. In examples, the network elements 130 may each include at least one of a server, a compute resource hardware, a network resource hardware, a data storage resource hardware, a network security appliance, and/or the like. The resources 135 and/or 140 may include at least one of compute resources (e.g., central processing units (“CPUs”), graphics processing units (“GPUs”), or other processors, and/or the like), network resources (e.g., fiber-based communications systems, switches, routers, etc.), data storage resources (e.g., disk storage devices, etc.), network security resources (e.g., firewall systems, Secure Access Service Edge (“SASE”) systems, etc.), and/or the like. In examples, network services provided by the compute resources may include processor-based network services, e.g., using the CPUs, GPUs, or other processors, or the like. In some examples, network services provided by the network resources may include virtual domain (“VDOM”)-based network services, software defined wide area network (“SDWAN”)-based network services, sessions-based network services, or bandwidth (“BW”)-based network services, and/or the like. In some instances, network services provided by the data storage resources may include memory-based network services, or the like. In some cases, network services provided by the network security resources may include firewall services, distributed denial of service (“DDoS”) prevention services, rapid threat defense (“RTD”) security services, zero trust network access (“ZTNA”)-based network services, or SASE-based network services (including SASE-based firewall services, SASE-based ZTNA services, SASE-based RTD services, and/or the like), and/or the like.

According to some embodiments, network(s) 125a-125c may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network(s) 125a-125c may include an access network of the service provider (e.g., an Internet service provider (“ISP”)). In another embodiment, the network(s) 125a-125c may include a core network of the service provider and/or the Internet.

In operation, computing system 105 and/or resource availability calculator 115a (or 115b) may be used to implement exponentially weighted scoring of calculated resource availability for automated network element selection, augmentation, and service delivery. For example, the computing system 105 and/or resource availability calculator 115a (or 115b) may receive the measurement data from measurement data source(s) (e.g., the measurement system(s) 145 or from database(s) 110 or 120, which may store the measurement data from the measurement system(s) 145). In response to receiving a resource request (e.g., resource request 150a, 150b, or 150c) from a requesting device (e.g., user device 155 associated with a first type of customer 160, user device 165 associated with a second type of customer 170, or user device 175 associated with a service provider agent 180, or the like), the computing system 105 and/or resource availability calculator 115a (or 115b) may calculate a weighted score for each of a plurality of resources 135 or 140 that is available on each of the plurality of network elements 130, in some cases, where those network elements have been determined to be capable of providing the requested network services. In some instances, the user devices 155 and 165 may each include, but is not limited to, one of a desktop computer, a laptop computer, a tablet computer, a smart phone, and/or a mobile phone, while user device 175 may include, without limitation, one of a desktop computer, a laptop computer, a tablet computer, a smart phone, a mobile phone, and/or a network operations center (“NOC”) computing system or console. In some cases, the first type of customer 160 is a customer of the service provider provisioning the network elements and/or resources who has already been provisioned with resources 135 and/or 140 being scored on at least one of the plurality of network elements 130, while the second type of customer 170 is a customer of service provider who has not already been provisioned with resources 135 and/or 140 being scored among the plurality of network elements. In an example, for network element A 130a being scored, if customer A is already being provisioned with some resources 135 on network element A, customer A would be considered a first type of customer 160. Further, for network element A 130a being scored, customer B (whether a new customer of the service provider or an existing customer of the service provider who has been provisioned with some resources 140 on network element 130n, but has not been provisioned with resources 135 on network element A) would be considered a second type of customer 170. The first and second types of customers may each include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

In some examples, each weighted score for a corresponding resource of the plurality of resources may be based on an exponential decay function of a difference between a limit value and a measured usage value, in some cases, according to the following equation:

$$Weighted {Score}_{Resource} = 10 , 000 \times Multiplier \times Weight \times ln ( max ( 1 , 100 \times ( Lim - Meas ) / Lim ) ) , \qquad ( Eqn . 1 )$$

where Multiplier may correspond to a discretionary adjustment that a service provider agent associated with provisioning the plurality of network elements may optionally input, the discretionary adjustment being a selectable value (e.g., a selectable percentage value or a selectable actual or non-percentage value, or the like). Weight may correspond to any suitable weighted value that may be applied to a particular resource among the plurality of resources that may be provided by a particular network element. In some instances, the weighted scores may include a set of weighted scores including at least one of weighted scores for processor-based network services, weighted scores for memory-based network services, weighted scores for VDOM-based network services, weighted scores for sessions-based network services, or weighted scores for BW-based network services, and/or the like. In some cases, the weighted scores for the processor-based network services, the memory-based network services, the VDOM-based network services, the sessions-based network services, and the BW-based network services may be different from each other, where a sum of the weighted scores for the plurality of resources that is available on each network element is set to 100%. In some cases, the Weight value may be chosen for each type of resource such that the sum of Weight values for the plurality of resources on a network element is set to 100%. The Lim value may correspond to a limit value for that resource on that network element for the type of customer or may correspond to an allocatable amount of the corresponding resource, while the Meas value may correspond to measured usage data or measurement data for that resource on that network element or may be based on the measurement data. The max function ensures that the natural logarithmic (In) function does not encounter a logarithm of zero error.

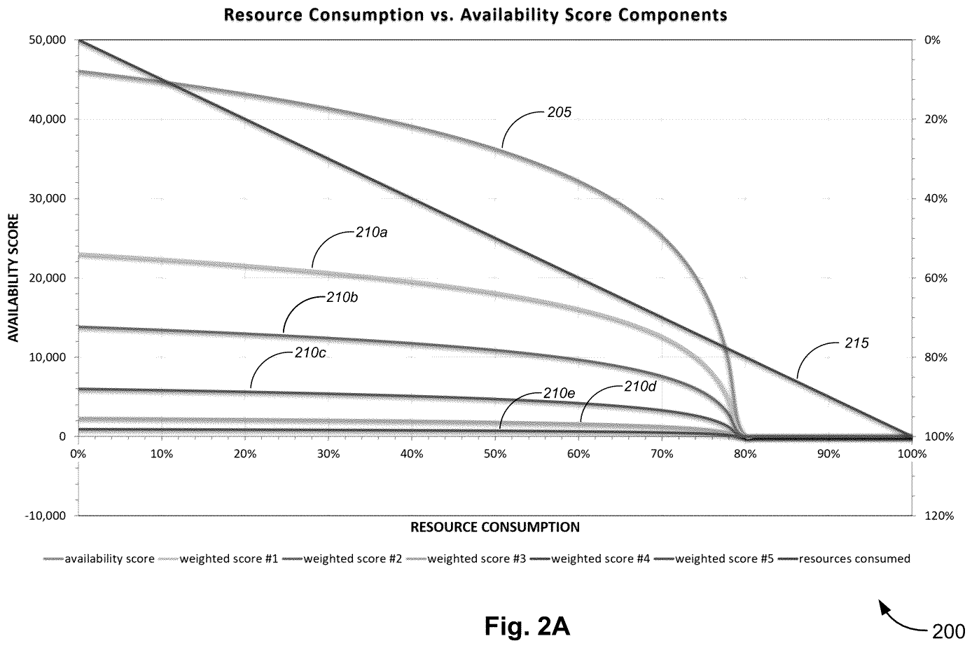

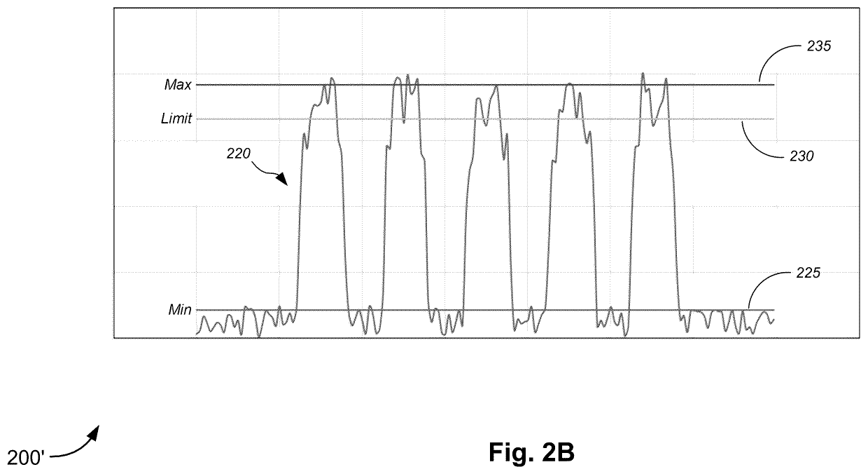

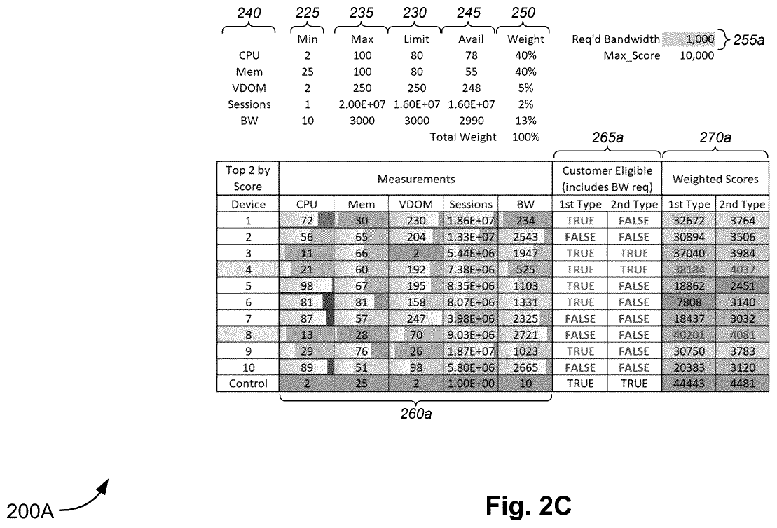

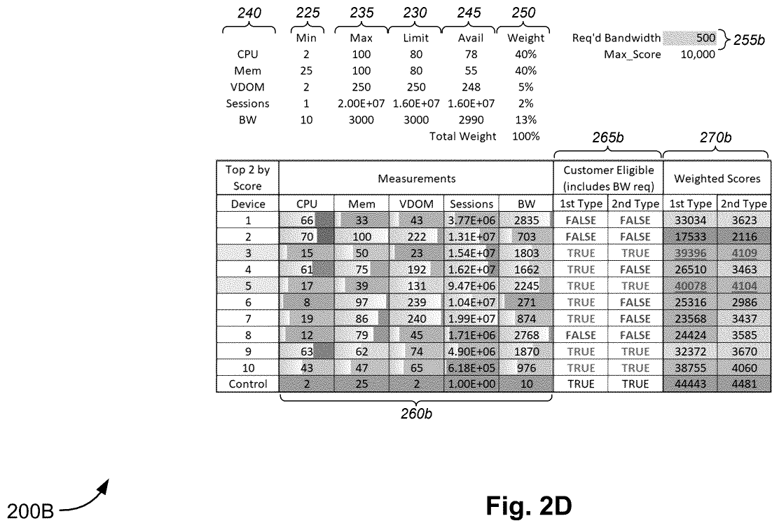

FIG. 2A depicts examples of the weighted scores for different resources on a network element (depicted in FIG. 2A as weighted scores #1 through #5 210a-210e) as a function of different percentages of resource consumption. Eqn. 1 above is merely a non-limiting example of an exponentially weighted score, and the various embodiments are not limited to a single equation or weighted score formula. In some cases, a singular formula may be adapted to be applied to all network services. In other cases, unique formulas may be applied to individual network services or any combination or groups/sets of network services, and/or the like. By extension, formula variability would also apply to all of the examples depicted in FIGS. 2A-2D, and their corresponding descriptions below. In examples, different network services may possess different limits, resource components, default component weights, default component limits, and/or different calculations of the weighted score per service being requested. In some cases, the weighted score for each network service is based on at least one of customizable weights, customizable formulas used to calculate weighted scores, or customizable network resources, and/or the like, for that network service. In some instances, at least one of weighted scores, weighted score calculation, weight values defined, or a unique set of network resources to which weight values are applied vary per network service being requested.

For each network element, computing system 105 and/or resource availability calculator 115a (or 115b) may calculate an availability score(s) 185 that is based on the weighted scores for resources of that network element. In an example, computing system 105 and/or resource availability calculator 115a (or 115b) may output the availability score(s) 185 for each of network elements of the plurality of network elements 130 that are capable of providing the requested resources. In another example, alternatively or additionally, computing system 105 and/or resource availability calculator 115a (or 115b) may determine, for each network element, whether that network element is available for providing the requested network services, based on the availability score for that network element, and may output a resource allocation decision 190 for that network element based on the determined availability of that network element for providing the requested network services. These and other functionalities of FIG. 1 are described below with respect to FIGS. 2A-4.

FIG. 2A depicts an example graphical representation 200 of resource consumption versus availability score components that corresponds to the exponentially weighted scoring of calculated resource availability for automated network element selection, augmentation, and service delivery, in accordance with various embodiments. FIG. 2B depicts an example graphical representation 200′ of maximum, minimum, and limited thresholds that may be used when implementing exponentially weighted scoring of calculated resource availability for automated network element selection, augmentation, and service delivery, in accordance with various embodiments. FIGS. 2C and 2D depict various example sets of calculation results 200A and 200B that correspond to implementation of exponentially weighted scoring of calculated resource availability for automated network element selection, augmentation, and service delivery, in accordance with various embodiments. As mentioned above, variability of the formula for calculating weighted scores applies to all of the examples depicted in FIGS. 2A-2D. Further, the five resources referred to with respect to FIGS. 2A-2D are merely representative of resources that may be considered in the generation of weighted scores for a particular service. One or more of these resources, none of these resources, or other resources in addition to these resources may be used for producing weighted scores and resource availability that are unique to a different service that is being delivered using a common set of network resources. For example, the resources available on a single network may produce different eligibility decisions for one product compared with another product based upon the specific resources, weights, and weighting formulas that are uniquely defined for each service.

With reference to FIG. 2A, availability score(s) 205 is plotted in example graphical representation 200 as a function of resource consumption in terms of percentage of use or measured usage, the availability score(s) 205 (from about 46,000 to 0 with 0 to 100% resource consumption, as shown on the left and bottom axes), for a given resource consumption percentage value, being based on a combination (in some cases, a sum) of a plurality of weighted scores #1 through #5 210a-210e that correspond to different types of resources provided by a network element. As described above with respect to FIG. 1, weighted scores #1 through #5 210a-210e may each be calculated based on Eqn. 1. Graphical line 215 corresponds to the consumed resources (in percentage value shown in the right axis). In FIGS. 2A-2D, the availability or weighted scores may be used in determining allocation decisions, with higher scores being more likely to be selected for allocation over lower scores. The scale shown in FIGS. 2A-2D is arbitrary and may be altered without departing from the scope of this disclosure.

Turning to FIG. 2B, an example resource usage 220 for a network element is shown, with the following thresholds depicted by horizontal lines in example graphical representation 200′: minimum threshold 225, limited threshold 230, and maximum threshold 235. The minimum threshold 225 may correspond to a base amount of resources that the network element consumes before being provisioned (in some cases, between about 5% and about 10% of the theoretical, statistical, or actual maximum resource capability over a set period (e.g., 30-day period, etc.)). The maximum threshold 235 may correspond to a maximum amount of resources that the network element is capable of providing, which may be an average maximum value (e.g., 95% or 100% of the statistical average maximum resource capability, or the like), a theoretical maximum resource (e.g., 95% or 100% of the theoretical maximum resource capability, or the like), or an actual maximum resource (e.g., 95% or 100% of the actual maximum resource capability, or the like). The limited threshold 230 may be less than the maximum threshold but greater than the minimum threshold, and may correspond to a set proportion of resources or a set amount of resources that is set by a service provider provisioning the plurality of network elements (in some cases, 80% of the theoretical, statistical, or actual maximum resource capability over the set period). In some instances, the limit value for the second type of customer corresponds to a difference between the limited threshold value and the minimum threshold value for the network element, while the limit value for the first type of customer corresponds to a difference between the maximum threshold value and the minimum threshold value for the network element.

Referring to FIGS. 2C and 2D, which depict example sets of calculation results 200A and 200B for devices 1 through 10 (e.g., network elements 130a-130n of FIG. 1, or the like), with example set 200A corresponding to a requested bandwidth resource of 1,000 Mbps, while example set 200B corresponds to a requested bandwidth resource of 500 Mbps. This is merely for purposes of illustration, and the requested resource may include any one or a combination of network resources described herein. In each of the devices or network elements, resources 240 that are provided by that device or network element include CPU-based network resources, memory-based network resources, VDOM-based network resources, sessions-based network resources, and BW-based network resources. The minimum thresholds 225 for these resources 240 may include 2 units, 25, units, 2 units, 1 unit, and 10 units for CPU-based network resources, memory-based network resources, VDOM-based network resources, sessions-based network resources, and BW-based network resources, respectively. The maximum thresholds 235 for these resources 240 may include 100 units, 100 units, 250 units, 20,000,000 units, and 3,000 units for CPU-based network resources, memory-based network resources, VDOM-based network resources, sessions-based network resources, and BW-based network resources, respectively. The limited thresholds 230 for these resources 240 may include 80 units, 80 units, 250 units, 16,000,000 units, and 3,000 units for CPU-based network resources, memory-based network resources, VDOM-based network resources, sessions-based network resources, and BW-based network resources, respectively.

The available amount 245 of resources may correspondingly be a difference between the limited threshold 230 and the minimum threshold 225 may be 78 units, 55 units, 248 units, 15,999,999 units (or ˜16,000,000 units), and 2,990 units for CPU-based network resources, memory-based network resources, VDOM-based network resources, sessions-based network resources, and BW-based network resources, respectively. The weight 250 applied for the device (or network element) may be 40%, 40%, 5%, 2%, and 13% for CPU-based network resources, memory-based network resources, VDOM-based network resources, sessions-based network resources, and BW-based network resources, respectively. The Control in FIGS. 2C and 2D correspond to the minimum threshold values 225. Herein, units may refer to any suitable unit of measure for each of the network resources. For example, one unit for CPU-based network resources may refer to one physical or virtual CPU core or other suitable unit, while one unit for memory-based network resources may refer to memory in terms of millions or billions of bytes (e.g., one MB or one GB, or the like). In examples, one unit of VDOM-based network resources may refer to one virtual domain, while one unit of sessions-based network resources may refer to one session. In some cases, one unit of BW-based network resources may refer to bandwidth in terms of megabits per second (or Mbps).

As shown in FIG. 2C, in response to, e.g., an input with a requested bandwidth 255a of 1,000 Mbps out of a maximum of 10,000 Mbps, the resource availability calculator (e.g., resource availability calculator 115a or 115b of FIG. 1, or the like) may indicate customer eligibility 265a for each of the devices (or network elements), based on usage measurement data 260a and based on whether the customer is a first type of customer or a second type of customer (as described in detail above with respect to FIG. 1), and may also calculate weighted scores 270a corresponding to the availability score(s) (e.g., availability score(s) 185 of FIG. 1 or availability score(s) 205 of FIG. 2A, or the like). In other words, if the measurements for BW-based network resources on a particular device (or network element) are below the limited threshold amount by more than the requested BW amount, then both the first type of customer and the second type of customer would be eligible (i.e., with the corresponding customer eligibility field 265a indicating “True”) for allocation of that resource on that particular device (or network element). On the other hand, if the measurements for BW-based network resources on a particular device (or network element) are above the limited threshold amount, but below the maximum threshold by more than the requested BW amount, then the first type of customer would be eligible (i.e., with the corresponding customer eligibility field 265a indicating “True”) while the second type of customer would not be eligible (i.e., with the corresponding customer eligibility field 265a indicating “False”) for allocation of that resource on that particular device (or network element). If the measurements for BW-based network resources on a particular device (or network element) are above the limited threshold amount and below the maximum threshold by less than the requested BW amount, then both the first type of customer and the second type of customer would not be eligible (i.e., with the corresponding customer eligibility field 265a indicating “False”) for allocation of that resource on that particular device (or network element).

For example, a first type of customer (i.e., a customer who has already been provisioned with resources from the corresponding devices or network elements) may be eligible (i.e., with the corresponding customer eligibility field 265a indicating “True”) for resources (including the requested BW) provided by devices (or network elements) 1, 3-6, and 9, with corresponding weighted scores (or availability scores) 270a of 32,672, 37,040, 38,184, 18,862, 7,808 and 30,750, respectively, but may be ineligible for resources (particularly the BW resources) provided by the other devices (or network elements) (i.e., with the corresponding customer eligibility field 265a indicating “False”). As further shown in FIG. 2C, a second type of customer (i.e., a customer who has not already been provisioned with resources from the corresponding devices or network elements) may be eligible (i.e., with the corresponding customer eligibility field 265a indicating “True”) for resources provided by devices (or network elements) 3 and 4, with corresponding weighted scores (or availability scores) 270a of 3,984 and 4,037, respectively, but may be ineligible for resources (particularly the BW resources) provided by the other devices (or network elements) (i.e., with the corresponding customer eligibility field 265a indicating “False”). The customer who has already been provisioned with the resources (i.e., the first type of customer) is given a broader range between the minimum and maximum thresholds, and thus is biased to have a higher weighted score (or availability score) compared with a customer who has not already been provisioned with the resources (i.e., the second type of customer) is given a more limited range between the minimum and limited thresholds.

As shown in FIG. 2D, in response to, e.g., an input with a requested bandwidth 255b of 500 Mbps out of a maximum of 10,000 Mbps, the resource availability calculator (e.g., resource availability calculator 115a or 115b of FIG. 1, or the like) may indicate customer eligibility 265b for each of the devices (or network elements), based on usage measurement data 260b and based on whether the customer is a first type of customer or a second type of customer (as described in detail above with respect to FIG. 1), and may also calculate weighted scores 270b corresponding to the availability score(s) (e.g., availability score(s) 185 of FIG. 1 or availability score(s) 205 of FIG. 2A, or the like). For example, a first type of customer (i.e., a customer who has already been provisioned with resources from the corresponding devices or network elements) may be eligible (i.e., with the corresponding customer eligibility field 265b indicating “True”) for resources (including the requested BW) provided by devices (or network elements) 3-7, 9, and 10, with corresponding weighted scores (or availability scores) 270a of 39,396, 26,510, 40,078, 25,316, 23,568, 32,372, and 38,755, respectively, but may be ineligible for resources (particularly the BW resources) provided by the other devices (or network elements) (i.e., with the corresponding customer eligibility field 265b indicating “False”). As further shown in FIG. 2D, a second type of customer (i.e., a customer who has not already been provisioned with resources from the corresponding devices or network elements) may be eligible (i.e., with the corresponding customer eligibility field 265b indicating “True”) for resources provided by devices (or network elements) 3, 5, 9, and 10, with corresponding weighted scores (or availability scores) 270b of 4, 109, 4,104, 3,670, and 4,060, respectively, but may be ineligible for resources (particularly the BW resources) provided by the other devices (or network elements) (i.e., with the corresponding customer eligibility field 265b indicating “False”). In FIGS. 2C and 2D, the weighed scores (or availability scores) 270a and 270b are depicted as generally being significantly different (i.e., by an order of magnitude) for the first type of customer compared to the second type of customer for purposes of illustration only; in practice, the weighted scores may be on the same order of magnitude.

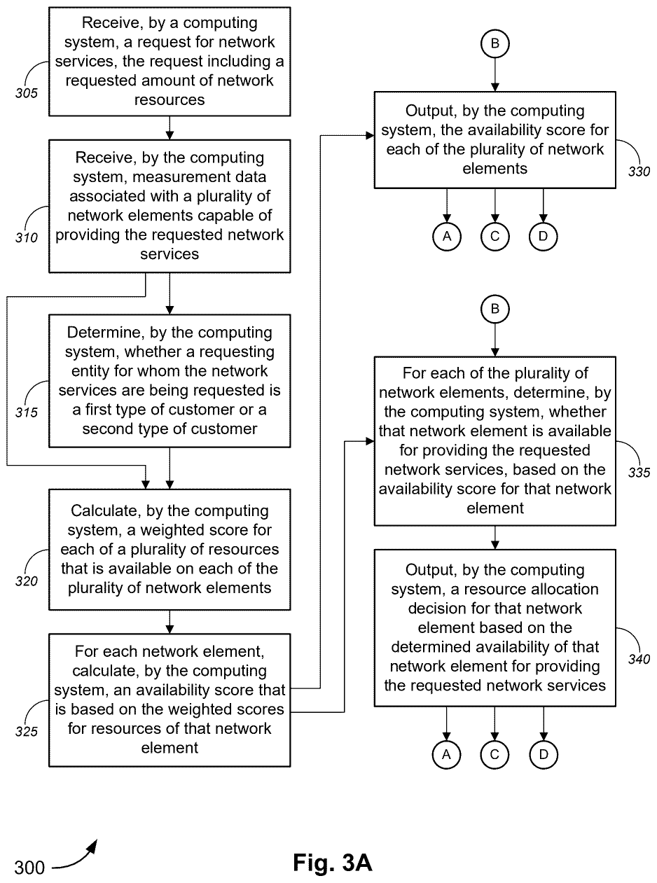

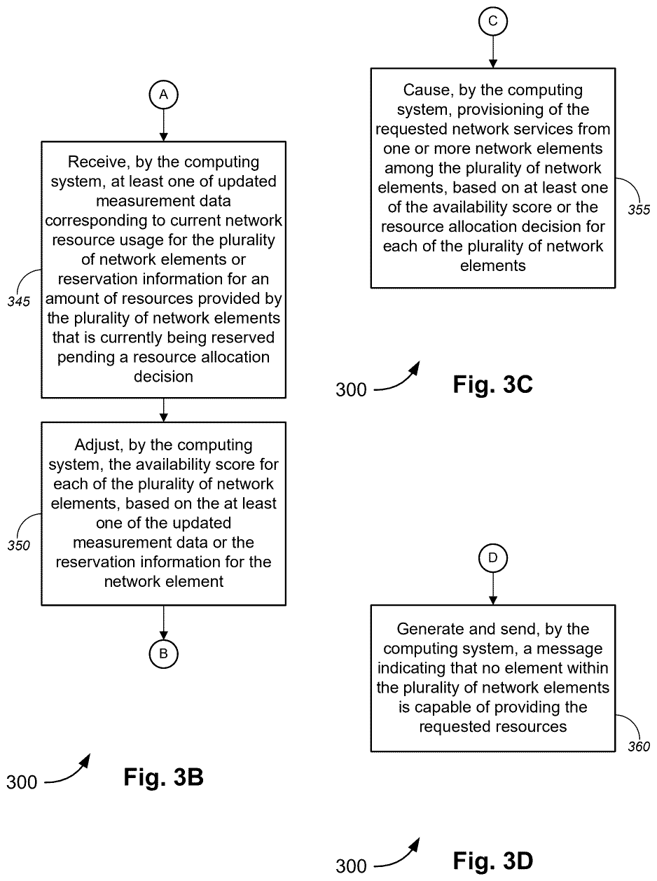

FIGS. 3A-3D depict flow diagrams illustrating an example method 300 for implementing exponentially weighted scoring of calculated resource availability for automated network element selection, augmentation, and service delivery, in accordance with various embodiments. Method 300 of FIG. 3A continues onto FIG. 3B following the circular marker denoted, “A,” and returns to FIG. 3A following the circular marker denoted, “B.” Method 300 of FIG. 3A continues onto FIG. 3C following the circular marker denoted, “C.” Method 300 of FIG. 3A continues onto FIG. 3D following the circular marker denoted, “D.”

With reference to FIG. 3A, method 300 may include, at operation 305, receiving, by a computing system (e.g., computing system 105 of FIG. 1, or the like), a request for network services (e.g., resource request 150a or 150b of FIG. 1, or the like). In an example, the request may include a requested amount of network resources. In other examples, if no specific amount is requested, a default amount of network resources may be provided. In some examples, the computing system includes at least one of a resource availability calculator (e.g., resource availability calculator 115 of FIG. 1, or the like), a network resource allocation system, a network services provisioning system, or a server, and/or the like. In examples, the request may be received via an API between the computing system and a requesting device, wherein the requesting device is either associated with a requesting entity or associated with an agent of a service provider provisioning the plurality of network elements.

At operation 310, the computing system may receive measurement data associated with a plurality of network elements (e.g., network elements 130a-130n of FIG. 1, or the like) capable of providing the requested network services. In an example, receiving the measurement data (at operation 310) may include receiving the measurement data from a database that stores collected measurement data associated with network elements including the plurality of network elements capable of providing the requested network services. Alternatively, in another example, receiving the measurement data (at operation 310) may include receiving the measurement data via an API between the computing system and each of one or more measurement data sources. Method 300 either may continue onto the process at operation 315 or may continue onto the process at operation 320 (skipping the process at operation 315).

At operation 315, method 300 may include determining, by the computing system, whether a requesting entity for whom the network services are being requested is a first type of customer (e.g., first type of customer 160 of FIG. 1, or the like)) who has already been provisioned with resources on at least one of the plurality of network elements or a second type of customer (e.g., second type of customer 170 of FIG. 1, or the like) who has not already been provisioned with resources on any of the plurality of network elements. In some examples, determining whether the requesting entity is the first type of customer or the second type of customer (at operation 315) may be performed based on at least one of: information regarding the requesting entity that is included in the request; information regarding the requesting entity that is accessed from a database associated with the service provider provisioning the plurality of network elements; and/or information obtained from network systems, sales systems, and/or ordering systems; and/or the like. In examples, any information source available to the service provider that can reasonably be used to determine the type of customer may be used.

At operation 320, the computing system may calculate a weighted score for each of a plurality of resources (e.g., resources 135a-135x and 140a-140y of FIG. 1, or the like) that is available on each of the plurality of network elements. In some examples, each weighted score for a corresponding resource of the plurality of resources may be based on an exponential decay function of a difference between a limit value and a measured usage value. In examples, the limit value may correspond to an allocatable amount of the corresponding resource. In some cases, the measured usage value is based on the measurement data. In some examples, the weighted scores for the plurality of resources that is available on each network element may correspond to one or more of a set of weight values for a network service, a set of weight values for a vendor of a network device, or a set of weight values for a network device. In some instances, the weighted scores may include a set of weighted scores including at least one of weighted scores for processor-based network services, weighted scores for memory-based network services, weighted scores for VDOM-based network services, weighted scores for sessions-based network services, or weighted scores for BW-based network services, and/or the like. In some cases, the weighted scores for the processor-based network services, the memory-based network services, the VDOM-based network services, the sessions-based network services, and the BW-based network services may be different from each other, where a sum of the weighted scores for the plurality of resources that is available on each network element is set to 100%.

In examples, each network element may have three threshold values that are used for calculating the availability score. The three threshold values may include a minimum threshold value, a limited threshold value, and a maximum threshold value. The minimum threshold value (e.g., minimum threshold 225 of FIG. 2B, or the like) may correspond to a base amount of resources that the network element consumes before being provisioned. The maximum threshold value (e.g., maximum threshold 235 of FIG. 2B, or the like) may correspond to a maximum amount of resources that the network element is capable of providing. The limited threshold value (e.g., limited threshold 230 of FIG. 2B, or the like) may be a value that is less than the maximum threshold value (but greater than the minimum threshold value) and that corresponds to a set proportion of resources or a set amount of resources that is set by a service provider provisioning the plurality of network elements. In some instances, the limit value for the second type of customer corresponds to a difference between the limited threshold value and the minimum threshold value for the network element, while the limit value for the first type of customer corresponds to a difference between the maximum threshold value and the minimum threshold value for the network element.

Method 300 may further include, at operation 325, for each network element, calculating, by the computing system, an availability score that is based on the weighted scores for resources of that network element. In examples, the availability score may be further based on a multiplier that corresponds to a discretionary adjustment that a service provider associated with provisioning the plurality of network elements optionally inputs, the discretionary adjustment being a selectable value (e.g., a selectable percentage value or a selectable actual value, or the like), such as described above with respect to FIG. 2. Method 300 either may continue onto the process at operation 330 and/or may continue onto the process at operation 335.

At operation 330, the computing system may output the availability score (e.g., availability score 175 of FIG. 1, or the like) for each of the plurality of network elements. Method 300 may continue onto the process at operation 345 in FIG. 3B following the circular marker denoted, “A,” and may return to either the process at operation 330 and/or the process at operation 335 in FIG. 3A following the circular marker denoted, “B.” Alternatively, method 300 may continue onto the process at operation 355 in FIG. 3C following the circular marker denoted, “C.” Alternatively, method 300 may continue onto the process at operation 360 in FIG. 3D following the circular marker denoted, “D.”

Alternatively or additionally, the method may further include, for each of the plurality of network elements, determining, by the computing system, whether that network element is available for providing the requested network services, based on the availability score for that network element (at operation 335); and outputting, by the computing system, a resource allocation decision (e.g., allocation decision 180 of FIG. 1, or the like) for that network element based on the determined availability of that network element for providing the requested network services (at operation 340). Method 300 may continue onto the process at operation 345 in FIG. 3B following the circular marker denoted, “A,” and may return to either the process at operation 330 and/or the process at operation 335 in FIG. 3A following the circular marker denoted, “B.” Alternatively, method 300 may continue onto the process at operation 355 in FIG. 3C following the circular marker denoted, “C.” Alternatively, method 300 may continue onto the process at operation 360 in FIG. 3D following the circular marker denoted, “D.”

At operation 345 in FIG. 3B (following the circular marker denoted, “A,” in FIG. 3A), method 300 may include receiving, by the computing system, at least one of updated measurement data corresponding to current network resource usage for the plurality of network elements or reservation information for an amount of resources provided by the plurality of network elements that is currently being reserved pending a resource allocation decision. Method may further include adjusting, by the computing system, the availability score for each of the plurality of network elements, based on the at least one of the updated measurement data or the reservation information for the network element (at operation 350). Method 300 may return to either the process at operation 330 and/or the process at operation 335 in FIG. 3A following the circular marker denoted, “B.”

At operation 355 in FIG. 3C (following the circular marker denoted, “C,” in FIG. 3A), method 300 may include causing, by the computing system, provisioning of the requested network services from one or more network elements among the plurality of network elements, based on at least one of the availability score or the resource allocation decision for each of the plurality of network elements.

At operation 360 in FIG. 3D (following the circular marker denoted, “D,” in FIG. 3A), method 300 may include generating and sending, by the computing system, a message indicating that no element within the plurality of network elements is capable of providing the requested resources.

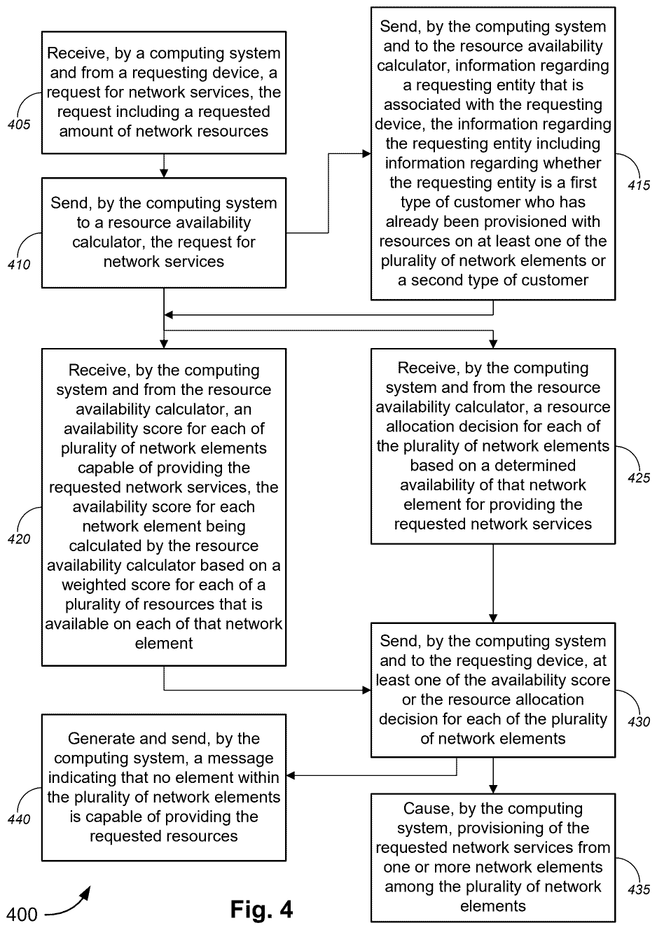

FIG. 4 depicts a flow diagram illustrating another example method 400 for implementing exponentially weighted scoring of calculated resource availability for automated network element selection, augmentation, and service delivery, in accordance with various embodiments. Method 400 is similar to method 300, except that while method 300 is performed from the perspective of a resource availability calculator that is either part of a computing system or from a remote resource availability calculator (e.g., resource availability calculator 115 of FIG. 1, or the like), method 400 is performed from the perspective of a computing system that is separate from a resource availability calculator (such as resource availability calculator 115 of FIG. 1, or the like). Method 400 is otherwise similar, if not identical to, method 300. Further, the descriptions above with respect to FIGS. 1-3D regarding the scope, defaults, customized formulas, weights, and/or network resources that may be evaluated on a per service basis (e.g., that were provided as described above with respect to method 300 of FIGS. 3A-3D, or the like) would similarly apply to method 400 of FIG. 4.

With reference to FIG. 4, method 400, at operation 405, may include receiving, by a computing system (e.g., computing system 105 of FIG. 1, or the like) and from a requesting device (e.g., user device 155 or 165 of FIG. 1, or the like), a request for network services. In an example, the request may include a requested amount of network resources. In other examples, if no specific amount is requested, a default amount of network resources may be provided. At operation 410, the computing system may send the request for network services to a resource availability calculator (e.g., resource availability calculator 115 of FIG. 1, or the like). Method 400 either may continue onto the process at operation 415 or may continue onto one or both of the process at operation 420 and/or the process at operation 425 (skipping the process at operation 415).

At operation 415, the computing system may send, to the resource availability calculator, information regarding a requesting entity that is associated with the requesting device. The information regarding the requesting entity may include information regarding whether the requesting entity is a first type of customer who has already been provisioned with resources on at least one of the plurality of network elements or a second type of customer who has not already been provisioned with resources on any of the plurality of network elements.

Method 400 may further include receiving, by the computing system and from the resource availability calculator, at least one of: an availability score for each of plurality of network elements capable of providing the requested network services (at operation 420); and/or a resource allocation decision for each of the plurality of network elements based on a determined availability of that network element for providing the requested network services (at operation 425). In examples, the availability score for each network element being calculated by the resource availability calculator based on a weighted score for each of a plurality of resources that is available on each of that network element. In some examples, each weighted score for a corresponding resource of the plurality of resources may be based on an exponential decay function of a difference between a limit value and a measured usage value. In examples, the limit value may correspond to an allocatable amount of the corresponding resource. In some cases, the measured usage value may be based on the measurement data. In some examples, the determined availability of that network element may be based on the availability score for that network element. Method 400 may further include, at operation 430 sending, by the computing system and to the requesting device, at least one of the availability score or the resource allocation decision for each of the plurality of network elements. Method 400 either may continue onto the process at operation 435 or may continue onto the process at operation 440. At operation 435, method 400 may include causing, by the computing system, provisioning of the requested network services from one or more network elements among the plurality of network elements, based on at least one of the availability score or the resource allocation decision for each of the plurality of network elements. At operation 440, method 400 may include generating and sending, by the computing system, a message indicating that no element within the plurality of network elements is capable of providing the requested resources.

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100, 200, 200′, 200A, and 200B of FIGS. 1, 2A, 2B, 2C, and 2D, respectively (or components thereof), such methods may also be implemented using any suitable hardware (or software) implementation. Similarly, while each of the systems, examples, or embodiments 100, 200, 200′, 200A, and 200B of FIGS. 1, 2A, 2B, 2C, and 2D, respectively (or components thereof), can operate according to the methods 300, 400 (e.g., by executing instructions embodied on a computer readable medium), the systems, examples, or embodiments 100, 200, 200′, 200A, and 200B of FIGS. 1, 2A, 2B, 2C, and 2D can each also operate according to other modes of operation and/or perform other suitable procedures.

### Exemplary System and Hardware Implementation

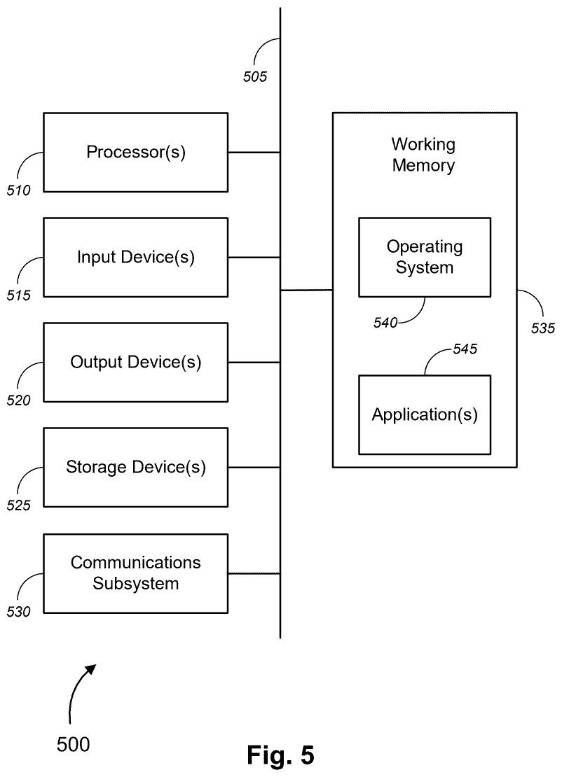

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing system 105, resource availability calculator 115, measurement system(s) 145, network elements 130a-130n, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing system 105, resource availability calculator 115, measurement system(s) 145, network elements 130a-130n, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by a computing system, a request for network services;
receiving, by the computing system, measurement data associated with a plurality of network elements capable of providing the requested network services;
calculating, by the computing system, a weighted score for each of a plurality of resources that is available on each of the plurality of network elements, wherein
each weighted score for a corresponding resource of the plurality of resources is based on an exponential decay function of a difference between a limit value and a measured usage value;
the limit value corresponds to an allocatable amount of the corresponding resource; and
the measured usage value is based on the measurement data;
for each network element, calculating, by the computing system, an availability score that is based on the weighted scores for resources of that network element; and
performing at least one of:
outputting, by the computing system, the availability score for each of the plurality of network elements; or
for each of the plurality of network elements,
determining, by the computing system, whether that network element is available for providing the requested network services, based on the availability score for that network element; and
outputting, by the computing system, a resource allocation decision for that network element based on the determined availability of that network element for providing the requested network services.

2. The method of claim 1, wherein the computing system comprises at least one of a resource availability calculator, a network resource allocation system, a network services provisioning system, or a server.

3. The method of claim 1, wherein the request is received via an API between the computing system and a requesting device, wherein the requesting device is either associated with a requesting entity or associated with an agent of a service provider provisioning the plurality of network elements.

4. The method of claim 1, wherein receiving the measurement data includes one of:
receiving the measurement data from a database that stores collected measurement data associated with network elements including the plurality of network elements capable of providing the requested network services; or
receiving the measurement data via an API between the computing system and each of one or more measurement data sources.

5. The method of claim 1, wherein each network element has three threshold values that are used for calculating the availability score, the three threshold values including a minimum threshold value, a limited threshold value, and a maximum threshold value, wherein the minimum threshold value corresponds to a base amount of resources that the network element consumes before being provisioned, the maximum threshold value corresponds to a maximum amount of resources that the network element is capable of providing, and the limited threshold value is a value that is less than the maximum threshold value and that corresponds to a set proportion of resources or a set amount of resources that is set by a service provider provisioning the plurality of network elements.

6. The method of claim 5, further comprising:
determining, by the computing system, whether a requesting entity for whom the network services are being requested is a first type of customer who has already been provisioned with resources on at least one of the plurality of network elements or a second type of customer who has not already been provisioned with resources on any of the plurality of network elements;
wherein the limit value for the second type of customer corresponds to a difference between the limited threshold value and the minimum threshold value for the network element, wherein the limit value for the first type of customer corresponds to a difference between the maximum threshold value and the minimum threshold value for the network element.

7. The method of claim 6, wherein determining whether the requesting entity is the first type of customer or the second type of customer is performed based on at least one of:
information regarding the requesting entity that is included in the request; or
information regarding the requesting entity that is accessed from a database associated with the service provider provisioning the plurality of network elements.

8. The method of claim 1, wherein the weighted scores for the plurality of resources that is available on each network element corresponds to one or more of a set of weight values for a network service, a set of weight values for a vendor of a network device, or a set of weight values for a network device, wherein at least one of weighted scores, weighted score calculation, weight values defined, or a unique set of network resources to which weight values are applied vary per network service being requested.

9. The method of claim 1, wherein the weighted scores include a set of weighted scores including at least one of weighted scores for processor-based network services, weighted scores for memory-based network services, weighted scores for virtual domain (“VDOM”)-based network services, weighted scores for sessions-based network services, or weighted scores for bandwidth (“BW”)-based network services, wherein the weighted scores for the processor-based network services, the memory-based network services, the VDOM-based network services, the sessions-based network services, and the BW-based network services are different from each other, wherein a sum of the weighted scores for the plurality of resources that is available on each network element is set to 100%.

10. The method of claim 1, further comprising:
causing, by the computing system, provisioning of the requested network services from one or more network elements among the plurality of network elements, based on at least one of the availability score or the resource allocation decision for each of the plurality of network elements.

11. The method of claim 1, further comprising:
receiving, by the computing system, at least one of updated measurement data corresponding to current network resource usage for the plurality of network elements or reservation information for an amount of resources provided by the plurality of network elements that is currently being reserved pending a resource allocation decision; and
adjusting, by the computing system, the availability score for each of the plurality of network elements, based on the at least one of the updated measurement data or the reservation information for the network element.

12. The method of claim 1, wherein the availability score is further based on a multiplier that corresponds to a discretionary adjustment that a service provider associated with provisioning the plurality of network elements optionally inputs, the discretionary adjustment being a selectable value.

13. A system, comprising:
a computing system, comprising:
a processing system; and
memory coupled to the processing system, the memory comprising computer executable instructions that, when executed by the processing system, causes the system to perform operations comprising:
receiving a request for network services;
receiving measurement data associated with plurality of network elements capable of providing the requested network services;
determining whether a requesting entity for whom the network services are being requested is a first type of customer who has already been provisioned with resources on at least one of the plurality of network elements or a second type of customer who has not already been provisioned with resources on any of the plurality of network elements;
calculating a weighted score for each of a plurality of resources that is available on each of the plurality of network elements, wherein
each weighted score for a corresponding resource of the plurality of resources is based on an exponential decay function of a difference between a limit value and a measured usage value;
the limit value corresponds to an allocatable amount of the corresponding resource; and
the measured usage value is based on the measurement data;
for each network element, calculating, by the computing system, an availability score that is based on weighted scores for resources of that network element, wherein the limit value for the second type of customer is less than the limit value for the first type of customer, such that the availability score is lower for the second type of customer than for the first type of customer;
performing at least one of:
outputting the availability score for each of the plurality of network elements; or
for each of the plurality of network elements,
determining whether that network element is available for providing the requested network services, based on the availability score for that network element, which is based on the type of customer; and
outputting a resource allocation decision for that network element based on the determined availability of that network element for providing the requested network services; and
performing one of:
causing provisioning of the requested network services from one or more network elements among the plurality of network elements, based on at least one of the availability score or the resource allocation decision for each of the plurality of network elements; or
generating and sending a message indicating that no element within the plurality of network elements is capable of providing the requested resources.

14. The system of claim 13, wherein each network element has three threshold values that are used for calculating the availability score, the three threshold values including a minimum threshold value, a limited threshold value, and a maximum threshold value, wherein the minimum threshold value corresponds to a base amount of resources that the network element consumes before being provisioned, the maximum threshold value corresponds to a maximum amount of resources that the network element is capable of providing, and the limited threshold value is a value that is less than the maximum threshold value and that corresponds to a set proportion of resources or a set amount of resources that is set by a service provider provisioning the plurality of network elements.

15. The system of claim 14, wherein the limit value for the second type of customer corresponds to a difference between the limited threshold value and the minimum threshold value for the network element, wherein the limit value for the first type of customer corresponds to a difference between the maximum threshold value and the minimum threshold value for the network element.

16. The system of claim 13, wherein the weighted scores include a set of weighted scores including weighted scores for processor-based network services, weighted scores for memory-based network services, weighted scores for virtual domain (“VDOM”)-based network services, weighted scores for sessions-based network services, and weighted scores for bandwidth (“BW”)-based network services, wherein the weighted scores for the processor-based network services, the memory-based network services, the VDOM-based network services, the sessions-based network services, and the BW-based network services are different from each other, wherein a sum of the weighted scores for the plurality of resources that is available on each network element is set to 100%.

17. The system of claim 13, wherein the weighted scores vary for different network services, wherein the weighted score for each network service is based on at least one of customizable weights, customizable formulas used to calculate weighted scores, or customizable network resources for that network service.

18. A method, comprising:
receiving, by a computing system and from a requesting device, a request for network services;
sending, by the computing system to a resource availability calculator, the request for network services;
receiving, by the computing system and from the resource availability calculator, at least one of:
an availability score for each of plurality of network elements capable of providing the requested network services, the availability score for each network element being calculated by the resource availability calculator based on a weighted score for each of a plurality of resources that is available on each of that network element, wherein
each weighted score for a corresponding resource of the plurality of resources is based on an exponential decay function of a difference between a limit value and a measured usage value;
the limit value corresponds to an allocatable amount of the corresponding resource; and
the measured usage value is based on measurement data associated with that network element; or
a resource allocation decision for each of the plurality of network elements based on a determined availability of that network element for providing the requested network services, the determined availability of that network element being based on the availability score for that network element;
sending, by the computing system and to the requesting device, at least one of the availability score or the resource allocation decision for each of the plurality of network elements; and
causing, by the computing system, provisioning of the requested network services from one or more network elements among the plurality of network elements, based on the at least one of the availability score or the resource allocation decision for each of the plurality of network elements.

19. The method of claim 18, wherein the request is sent via an API between the computing system and the resource availability calculator.

20. The method of claim 18, further comprising:
sending, by the computing system and to the resource availability calculator, information regarding a requesting entity that is associated with the requesting device, the information regarding the requesting entity including information regarding whether the requesting entity is a first type of customer who has already been provisioned with resources on at least one of the plurality of network elements or a second type of customer who has not already been provisioned with resources on any of the plurality of network elements;
wherein the limit value for the second type of customer is less than the limit value for the first type of customer, such that the availability score is lower for the second type of customer than for the first type of customer.
